(19) United States
(12) Patent Application Publication
(10) Pub. No.: US 2021/0355909 A1
(43) Pub. Date: Nov. 18, 2021

(54) TURBINE ENGINE WITH WIND TRAP BLADES AND FLOATING DRUM

(71) Applicant: Henry J. Pienczykowski, Kew Gardens, NY (US)

(72) Inventor: Henry J. Pienczykowski, Kew Gardens, NY (US)

(21) Appl. No.: 17/301,959

(22) Filed: Apr. 20, 2021

Related U.S. Application Data
(60) Provisional application No. 62/704,555, filed on May 15, 2020.

(51) Int. Cl. F03D 3/04; F03D 3/00

(52) U.S. Cl. CPC F03D 3/0409; F03D 3/005; F05B 2240/12; F05B 2220/30; F05B 2210/12

(57) ABSTRACT

A wind funnel includes airflow chambers. Each airflow chamber has sidewalls forming an external cross-sectional area greater than an internal cross-sectional area. A wind turbine engine includes a turbine drum and the wind funnel. The turbine drum has turbine blades extending from the drum that rotate a centrally positioned vertical shaft. The airflow chambers conduct external air to, and increase air pressure compared to ambient air pressure by a predetermined ratio at, the turbine blades.

### CROSS-REFERENCE TO RELATED APPLICATION

This application claims the benefit of priority of U.S. provisional application No. 62/704,555, filed May 15, 2020, the contents of which are herein incorporated by reference.

### BACKGROUND OF THE INVENTION

The present invention relates to wind turbine engines and, more particularly, to turbine engines with a wind trap.

Currently available wind turbines do not trap or compress wind to increase power efficiency. The failure to use wind square footage to increase efficiency and maximize wind force is environmentally wasteful. Moreover, existing wind turbines are very expensive, harm birds, and are limited in location by size.

As can be seen, there is a need for an inexpensive wind turbine with better power efficiency that does not harm birds and can be placed in locations not suitable for current wind turbines.

### SUMMARY OF THE INVENTION

The inventive wind turbine apparatus guides wind through a wind trap to the turbine. In many cases, wind enters the wind trap through an intake boundary having, e.g., a surface area of about 100 square feet (sq. ft.) and is compressed, entering the turbine drum by way of a port having, e.g., a boundary surface area of about 10 sq. ft. In other words, the air is compressed by ten times or more, increasing the force on the turbine. Moreover, the inventive turbine may float on magnets within its frame, reducing friction. The increased force on the turbine and the lack of friction maximizes energy conversion. The inventive wind turbine may be geared for maximum drive speed. The increase in energy conversion renders the invention particularly environment friendly.

The wind trap and the turbine generally have no external moving parts to kill birds. The inventive apparatus may be made in many sizes, strengths, and/or shapes and takes up less area than a conventional turbine, allowing the apparatus to be installed anywhere with wind, in all terrain, wherever an axle drive may be needed. The inventive wind turbine may be relatively cheap in comparison to existing wind turbines, allowing the operator to make money selling electricity.

In one aspect of the present invention, a wind turbine engine is provided comprising a turbine drum comprising turbine blades extending therefrom, operative to rotate a vertical shaft centrally positioned therein; and a wind funnel with airflow chambers, each said airflow chamber having sidewalls forming an external cross-sectional area and an internal cross-sectional area, wherein the external cross-sectional area is greater than the internal cross-sectional area and wherein the airflow chambers are operative to conduct external air to the turbine blades and to increase air pressure at the turbine blades as compared to ambient air pressure by a predetermined ratio.

In another aspect of the present invention, a wind funnel for compressing air entering a wind turbine is provided, comprising: at least one airflow chamber having sidewalls forming an external cross-sectional area and an internal cross-sectional area, wherein the external cross-sectional area is greater than the internal cross-sectional area and wherein the airflow chambers are operative to conduct external air to the wind turbine and to increase air pressure at the wind turbine as compared to ambient air pressure by a predetermined ratio.

These and other features, aspects and advantages of the present invention will become better understood with reference to the following drawings, description, and claims.

### BRIEF DESCRIPTION OF THE DRAWINGS

FIG. 1 is a side view of a turbine engine according to an embodiment of the present invention, as well as a top view of a turbine, and a perspective view of a turbine blade;

FIG. 2 is a side view of a wind funnel thereof, with an exploded view of the wind blade;

FIG. 3 is a front view thereof;

FIG. 4 is a top diagrammatic view of the wind funnel of FIG. 2;

FIG. 5 is a cross-sectional view of a gear assembly and the lower part of the base thereof;

FIG. 6 is a bottom view thereof; and

FIG. 7 is a bottom view of the turbine engine of FIG. 1.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a wind turbine engine provided with a wind funnel configured to compress incoming wind so that air enters the turbine at a pressure substantially higher than standard atmospheric pressure. The inventive apparatus produces power without harming the environment.

As used herein, the term “engine” means an apparatus that derives energy from wind.

The inventive wind turbine may be built to the needs of the location and terrain and may be erected outside or inside a structure, including on top of or inside a building, boats, cars, trucks, trains, motor homes, etc. The apparatus may be used with any machine or device that can use axle drive to power, such as to produce power for ac/dc power plants (i.e., electric power plants) or generators, to turn mills, to power water pumps, and combinations thereof. The wind turbine may be adapted to industry system water needs, etc.

Within the identified region, the turbine is preferably erected in an area with the most dependable wind patterns. In some cases, an upper funnel housing platform (turret) of the wind turbine may turn into the wind to obtain the full wind force, e.g., with a small sleeve gear. For example, the rotatable housing or turret may turn between about 35° and about 60°, such as between about 45° and about 50°, preferably no more than about 45°, to obtain maximum wind flow into the funnel, maximizing force.

The wind funnel includes at least one airflow chamber, such as about four airflow chambers, operative to conduct external air to the turbine. Each airflow chamber has sidewalls forming an external cross-sectional area and an internal cross-sectional area. increase air pressure compared to ambient air pressure by a predetermined ratio. In embodiments having a sleeve encircling the turbine drum, the sleeve may have ports and each chamber may align with one of the sleeve ports.

As wind enters the funnels, the turbine generally spins a large gear that drives a small gear and an axle that is connected to a receiving apparatus, such as an ac/dc power plant. The axle is generally operative to power the receiving apparatus.

The wind turbine is generally supported by an axle or shaft that, in some cases, may be stabilized by several shaft stabilizers or wheels. For example, the wind turbine may have a centrally positioned vertical shaft therein. Preferably, a friction resistant mat is positioned between an upper platform and a lower platform supporting the turbine drum.

In some embodiments, the shape and height of the wind trap are characterized by dimensions providing a ratio of area of a face port to a turbine port of at least about 10 to 1, compressing the air about 10 or more times, thereby increasing the wind pressure by about 10 to 1 from the funnel entrance to the blade traps. The ratio may be achieved, for example, by providing upper, lower, left, and/or right guide panels positioned at a predetermined angle.

The wind trap or funnel may be manufactured from any suitable materials. Preferably the panels of the wind funnel are manufactured from friction-resistant materials to lessen stress on panels under high winds. The length of each wind funnel blade may vary from the other panels such that each panel is adapted to the dimensions of the portion of the wind funnel in which it is placed. For example, two center blades may have a length greater than two peripheral blades. Generally, although not intending to be limiting, the wind funnel blades may be positioned equidistant within the funnel port or entry. All parts may be weatherproofed and may be manufactured of rust resistant material. In some embodiments, cables may connect the lower platform to ground weights. A cross cable may be provided in front of the funnel to open the guide panels. Concrete moorings may be provided in some cases for heavy duty operation. Crosscut turbine traps and funnel panels may be provided, for example, in 1-foot sections.

The wind turbine and funnel may be mobile and may be cheap and easy to install. The apparatus may be transported as a kit with assembly on site or it may be preassembled, either as a complete unit or in sections small enough to fit through doorways or elevators, i.e., turbine, housing, funnels, platforms, etc.

In some embodiments, lights may be added to discourage birds from landing on the apparatus at night and to discourage owls during the daytime.

In some embodiments, the wind turbine may be levitated, i.e., a floated drum and a stabilized axle, to maximize efficiency. Preferably, the turbine may be levitated magnetically, e.g., with magnetic plates, collars, and/or cylinders. Alternatively, the wind turbine may be supported on rollers or ball bearings or may float in a tub containing fluid such as water or oil. This minimizes friction to the turbine and axle.

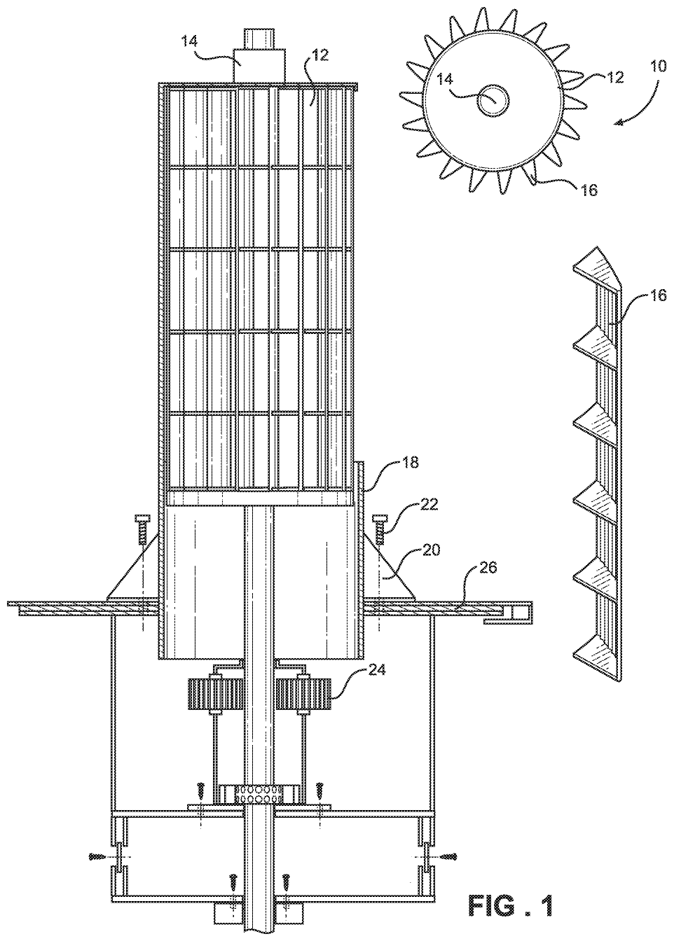

Referring to FIGS. 1 through 7, FIG. 1 illustrates a wind turbine engine 10 having a wind turbine or turbine drum 12 that rotates within a turbine sleeve 18 when wind presses a turbine blade 16 extending from the turbine drum 12, turning a shaft or axle 14. The axle 14 may rotate a large gear 24. Shaft stabilizers (not shown) may be provided above the turbine 12. Turbine blades 16 may have wind trap compartments separated by wind trap shelves extending from the turbine blades 16. The turbine sleeve 18 may be joined to a base plate 26 by way of screws 22. The wind turbine 12 may float on magnets (not shown).

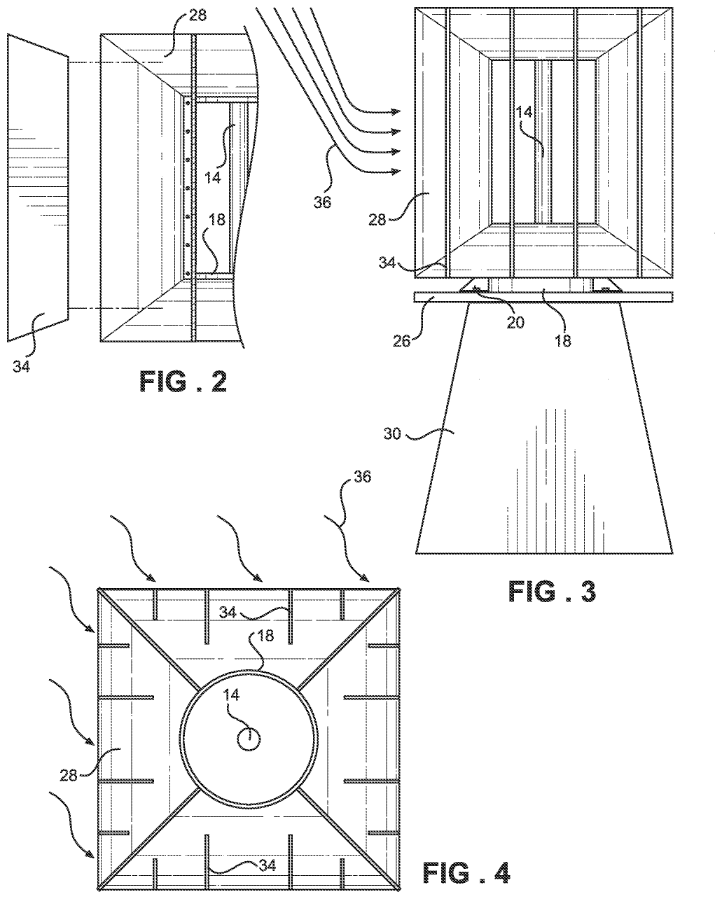

As shown in FIG. 2 through 4, a wind funnel or horn 28 may be positioned around the turbine sleeve 18 on top of a base support 20, which is in turn attached to the base plate 26 atop a base 30 of the wind turbine engine. Wind 36 is generally guided into the turbine 12 by guide panels or wind funnel blades 34. The wind funnel blades 34 may have an orientation selected from the group consisting of: vertically oriented, horizontally oriented, and a combination thereof. Hinged blowout panels (not shown) may provide safety and protect the housing (not shown) by relieving pressure from high wind speeds. Together, the elements of the wind funnel 28 prevent birds from entering the turbine 12 and being killed by the turbine blades 16. As wind 36 enters the wind funnel 28, air is compressed, driving turbine blades 16 and causing the axle 14 to turn. The boundary surface area of a wind funnel 28 entrance or port may be at least about 10 times larger than the boundary surface area of the corresponding port between the wind funnel 28 and the turbine sleeve 18. The distance between wind funnel blades 34 is generally not more than about 33%, or ⅓, of the wind turbine 12 radius.

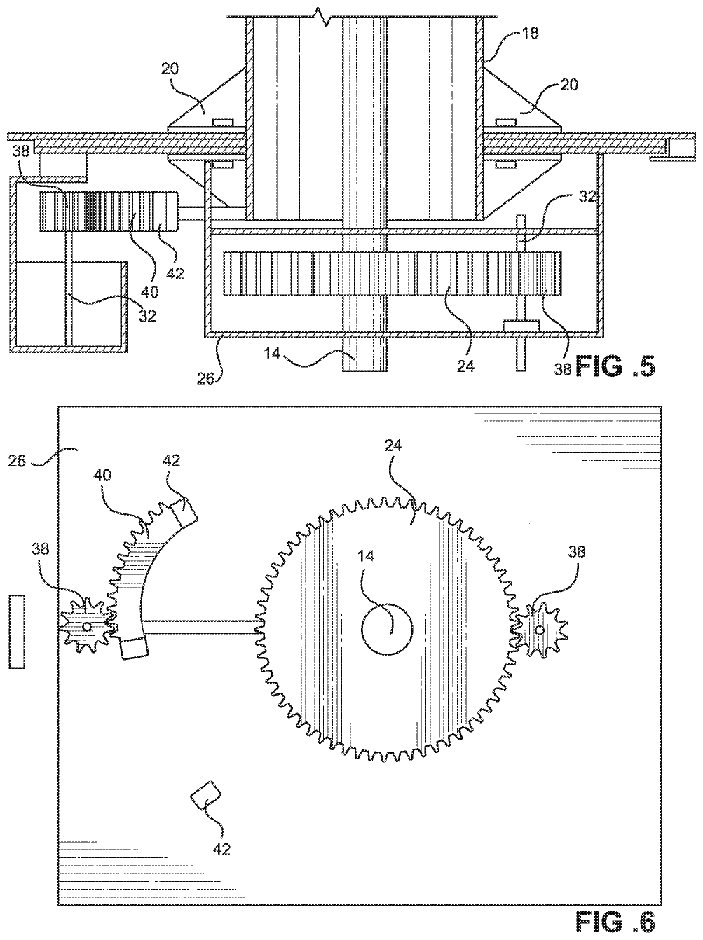

FIGS. 5 and 6 illustrate the gear box assembly. A large gear 24 engages small gears 38 secured on small axles 32. One small gear 38 further engages a half gear 40, rotating the half gear 40 between two gear stops 42. The gear assembly converts kinetic energy from the wind rotating the turbine into electricity directly or indirectly or into another form of potential energy.

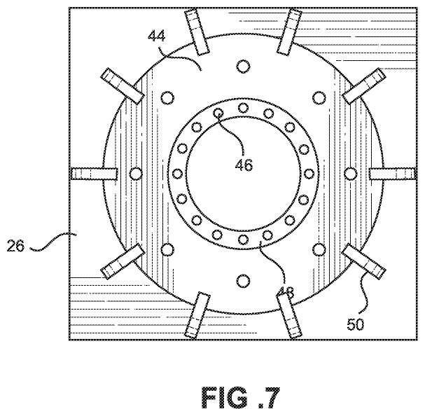

As FIG. 7 shows, the lower surface of the base plate or platform 26 may be coupled to a lower platform 44 with lower platform supports or collars 50. Ports 46 in a turbine sleeve 48 are also illustrated. The lower platform 44 may, in some cases, be substantially circular.

It should be understood, of course, that the foregoing relates to exemplary embodiments of the invention and that modifications may be made without departing from the spirit and scope of the invention as set forth in the following claims.

What is claimed is:

1. A wind turbine engine comprising:
a) a turbine drum comprising turbine blades extending therefrom, operative to rotate a vertical shaft centrally positioned therein; and
b) a wind funnel with airflow chambers, each said airflow chamber having sidewalls forming an external cross-sectional area and an internal cross-sectional area, wherein the external cross-sectional area is greater than the internal cross-sectional area and wherein the airflow chambers are operative to conduct external air to the turbine blades and to increase air pressure at the turbine blades as compared to ambient air pressure by a predetermined ratio.

2. The wind turbine engine of claim 1, wherein the wind funnel further comprises a rotatable housing.

3. The wind turbine engine of claim 1, wherein the predetermined ratio is at least about 10 to 1.

4. The wind turbine engine of claim 1, wherein the wind funnel comprises guide panels positioned at a predetermined angle.

5. The wind turbine engine of claim 1, wherein the turbine drum is a floated drum.

6. The wind turbine engine of claim 1, wherein the turbine blades further comprise wind trap shelves extending therefrom forming wind trap compartments within each of the turbine blades.

7. The wind turbine engine of claim 1, wherein the turbine drum is encircled by a turbine sleeve joined to a base plate and the turbine sleeve is encircled by the wind funnel on top of a base support, wherein the turbine sleeve has sleeve ports, each of the sleeve ports aligned with one of the airflow chambers.

8. The wind turbine engine of claim 7, wherein the base plate is coupled to a lower platform and the base support is attached to the base plate.

9. The wind turbine engine of claim 1, wherein the vertical shaft is operative to rotate at least one gear and the at least one gear is operative to rotate an axle.

10. The wind turbine engine of claim 9, wherein the axle is operative to power a receiving apparatus selected from the group consisting of: an electric power plant, a generator, a water pump, and combinations thereof.

11. A wind funnel for compressing air entering a wind turbine, comprising: at least one airflow chamber having sidewalls forming an external cross-sectional area and an internal cross-sectional area, wherein the external cross-sectional area is greater than the internal cross-sectional area and wherein the airflow chambers are operative to conduct external air to the wind turbine and to increase air pressure at the wind turbine as compared to ambient air pressure by a predetermined ratio.

12. The wind funnel of claim 11, wherein about four airflow chambers are provided.

13. The wind funnel of claim 11, further comprising a rotatable housing.

14. The wind funnel of claim 11, wherein the predetermined ratio is at least about 10 to 1.

15. The wind funnel of claim 11, further comprising guide panels within the at least one airflow chamber with an orientation selected from the group consisting of vertical, horizontal, and a combination thereof.
